(19) United States
(12) Patent Application Publication
(10) Pub. No.: US 2011/0149259 A1
(43) Pub. Date: Jun. 23, 2011

(54) LITHOGRAPHIC APPARATUS

(75) Inventors: Ronald Cornelis Gerardus GIJZEN, Liempde (NL); Christiaan Alexander Hoogendam, Westerhoven (NL); Sander Alexander Christiaan Franken, Eindhoven (NL); René Boerhof, 's-Hertogenbosch (NL)

(73) Assignee: ASML NETHERLANDS B.V., Veldhoven (NL)

(21) Appl. No.: 12/970,216

(22) Filed: Dec. 16, 2010

Related U.S. Application Data
(60) Provisional application No. 61/289,092, filed on Dec. 22, 2009.

(51) Int. Cl. G03B 27/52; B65B 23/00; B65D 81/20; B65B 31/02

(52) U.S. Cl. 355/30; 53/472; 53/432; 206/521

(57) ABSTRACT

A container is provided for use within a lithographic apparatus. The container is configured to house at least one component of the lithographic apparatus within an internal space which is at least partially filled with a packing material that includes a plurality of gas cells.

### CROSS-REFERENCE TO RELATED APPLICATIONS

This application claims the benefit of priority from U.S. Provisional Patent Application No. 61/289,092, filed Dec. 22, 2009, the content of which is incorporated herein by reference in its entirety.

### FIELD

The present invention relates to a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k₁.

In order to shorten the exposure wavelength and, thus, reduce the minimum printable size, it has been proposed to use an extreme ultraviolet (EUV) radiation source. EUV radiation is electromagnetic radiation having a wavelength within the range of 10-20 nm, for example within the range of 13-14 nm. It has further been proposed that EUV radiation with a wavelength of less than 10 nm could be used, for example within the range of 5-10 nm such as 6.7 nm or 6.8 nm. Such radiation is termed extreme ultraviolet radiation or soft x-ray radiation. Possible sources include, for example, laser-produced plasma sources, discharge plasma sources, or sources based on synchrotron radiation provided by an electron storage ring.

EUV radiation may be produced using a plasma. A radiation system for producing EUV radiation may include a laser for exciting a fuel to provide the plasma, and a source collector module for containing the plasma. The plasma may be created, for example, by directing a laser beam at a fuel, such as particles of a suitable material (e.g. tin), or a stream of a suitable gas or vapor, such as Xe gas or Li vapor. The resulting plasma emits output radiation, e.g., EUV radiation, which is collected using a radiation collector. The radiation collector may be a mirrored normal incidence radiation collector, which receives the radiation and focuses the radiation into a beam. The source collector module may include an enclosing structure or chamber arranged to provide a vacuum environment to support the plasma. Such a radiation system is typically termed a laser produced plasma (LPP) source.

EUV radiation is generally, absorbed by most materials. It may therefore be desirable to provide in a lithographic apparatus a vacuum chamber, for example which may be evacuated using a vacuum pump, through which the beam of EUV radiation may pass. As will be appreciated, at least some of the components of the lithographic apparatus may need to be located within the vacuum chamber. However, some components may introduce challenges if they are located within the vacuum chamber. For example, some components may be damaged by the conditions within the vacuum chamber and/or operate in a sub-optimal manner.

Alternatively or additionally, for example, some components may have a detrimental effect on the function of the vacuum chamber. For example, some components may include materials with high outgassing which may prevent the desired vacuum level being achieved or make it difficult to attain.

It is desirable to provide a system for housing components within a vacuum chamber of a lithographic apparatus.

According to an aspect of the invention, there is provided a lithographic apparatus subsystem, comprising: a sealed container housing at least one component of the lithographic apparatus within an internal space of the sealed container; wherein at least part of the internal space of the container is filled with a packing material comprising a plurality of gas cells.

The packing material may selected such that, if the packing material were exposed to a pressure of less than about 0.1 bar, the plurality of gas cells would not burst. The packing material may selected such that, if the packing material were exposed to a pressure of less than about 0.05 bar, the plurality of gas cells would not burst. The packing material may selected such that, if the packing material were exposed to absolute vacuum, the plurality of gas cells would not burst. The packing material may selected such that, if filler material is injected into the sealed container at a pressure of between about 1 bar and about 10 bar, the plurality of gas cells would not burst. The packing material may be selected such that, if filler material is injected into the sealed container at a pressure of about 6 bar, the plurality of gas cells would not burst.

According to an aspect of the invention, there is provided a method of preparing a sealed container for use in a lithographic apparatus, comprising: providing at least one component of the lithographic apparatus within an internal space of the container; and providing a packing material to the internal space of the container; wherein the packing material comprises a plurality of gas cells.

The filler material may be injected into the internal space of the container at a pressure of between about 1 bar and about 10 bars, for instance about 3 bars, about 4 bars or about 6 bars.

According to an aspect of the invention, there is provided a container for use within a lithographic apparatus. The container houses at least one component of the lithographic apparatus within an internal space which is at least partially filled with a packing material comprising a plurality of gas cells.

According to an aspect of the invention, there is provided a lithographic apparatus, comprising a support configured to support a patterning device. The patterning device is configured to pattern a beam of radiation to form a patterned beam of radiation. The lithographic apparatus also includes a projection system configured to project the patterned beam of radiation onto a substrate, and a lithographic apparatus subsystem, comprising a sealed container which houses at least one component of the lithographic apparatus within an internal space of the sealed container, wherein at least part of the internal space of the container is filled with a packing material comprising a plurality of gas cells.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 is a more detailed view of the apparatus of FIG. 1;

FIG. 3 is a more detailed view of a source collector module of the apparatus of FIGS. 1 and 2;

FIG. 4 depicts a lithographic apparatus subsystem that includes a container for a component of a lithographic apparatus according to an embodiment of the invention;

FIG. 5 depicts a lithographic apparatus subsystem that includes a container for a component of a lithographic apparatus according to an embodiment of the invention; and

FIG. 6 depicts a lithographic apparatus subsystem that includes a container for a component of a lithographic apparatus according to an embodiment of the invention.

### DETAILED DESCRIPTION

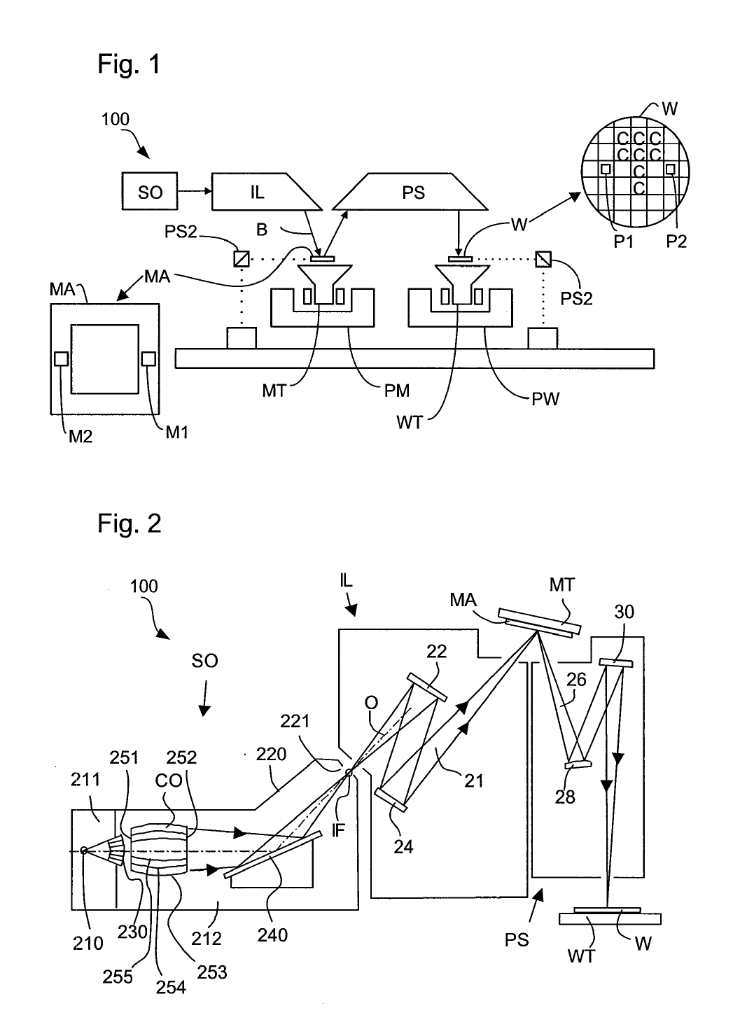

FIG. 1 schematically depicts a lithographic apparatus 100 including a source collector module SO according to one embodiment of the invention. The apparatus comprises: an illumination system (illuminator) IL configured to condition a radiation beam B (e.g. EUV radiation); a support structure (e.g. a mask table) MT constructed to support a patterning device (e.g. a mask or a reticle) MA and connected to a first positioner PM configured to accurately position the patterning device; a substrate table (e.g. a wafer table) WT constructed to hold a substrate (e.g. a resist-coated wafer) W and connected to a second positioner PW configured to accurately position the substrate; and a projection system (e.g. a reflective projection system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device, MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with, a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

As here depicted, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (“LPP”), the required plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g., EUV radiation, which is collected using a radiation collector, disposed in the source collector module. The laser and the source collector module may be separate entities, for example when a CO₂ laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma EUV generator, often termed as a DPP source.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder or capacitive sensor), the substrate table WT can be moved accurately, e.g. so as to position different target portions C in the path of the radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

The depicted apparatus could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.
2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-) magnification and image reversal characteristics of the projection system PS.
3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge causing an at least partially ionized plasma. Partial pressures of, for example, 10 Pa of Xe, Li, Sn vapor or any other suitable gas or vapor may be required for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure, as known in the art.

The collector chamber 212 may include a radiation collector CO which may be a so-called grazing incidence collector. Radiation collector CO has an upstream radiation collector side 251 and a downstream radiation collector side 252. Radiation that traverses collector CO can be reflected off a grating spectral filter 240 to be focused in a virtual source point IF. The virtual source point IF is commonly referred to as the intermediate focus, and the source collector module is arranged such that the intermediate focus IF is located at or near an opening 221 in the enclosing structure 220. The virtual source point IF is an image of the radiation emitting plasma 210.

Subsequently, the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the wafer stage or substrate table WT.

More elements than shown may generally be present in illumination optics unit IL and projection system PS. The grating spectral filter 240 may optionally be present, depending upon the type of lithographic apparatus. Further, there may be more mirrors present than those shown in the Figures, for example there may be 1-6 additional reflective elements present in the projection system PS than shown in FIG. 2.

Collector optic CO, as illustrated in FIG. 2, is depicted as a nested collector with grazing incidence reflectors 253, 254 and 255, just as an example of a collector (or collector mirror). The grazing incidence reflectors 253, 254 and 255 are disposed axially symmetric around an optical axis O and a collector optic CO of this type is preferably used in combination with a discharge produced plasma source, often called a DPP source.

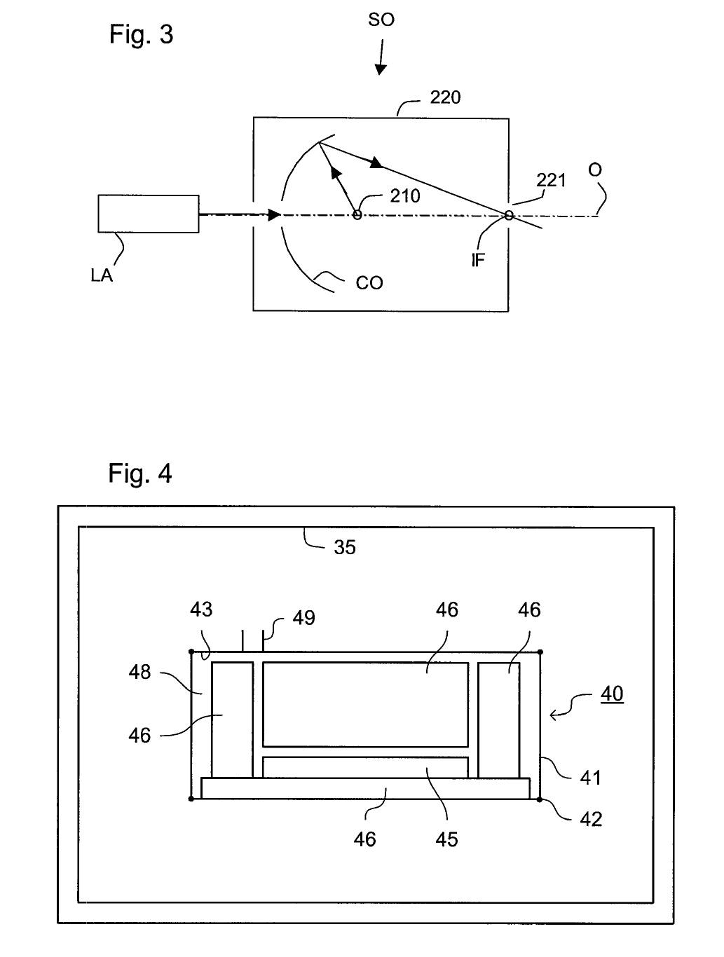

Alternatively, the source collector module SO may be part of an LPP radiation system as shown in FIG. 3. A laser LA is arranged to deposit laser energy into a fuel, such as xenon (Xe), tin (Sn) or lithium (Li), creating the highly ionized plasma 210 with electron temperatures of several 10's of eV. The energetic radiation generated during de-excitation and recombination of these ions is emitted from the plasma, collected by a near normal incidence collector optic CO and focused onto the opening 221 in the enclosing structure 220.

In order to house components of a lithographic apparatus such that they may be used within a vacuum chamber, it has been previously been proposed to seal the components within a metal container. For example, a container may be formed with welded seams in order to be gas tight. This may be useful for components with materials with high outgassing which may make it difficult or impossible to reach the desired vacuum level, namely to reduce the pressure within the vacuum chamber to a desired level. In addition, housing components within such a container may protect the components from aggressive H+ radicals, which may be present within a vacuum chamber for use in a lithographic apparatus using EUV radiation. Specifically, the H+ radicals may be used for cleaning surfaces of the apparatus. For example, NdFeB magnets may be damaged by H+ radicals.

However, provision of such a container may introduce new challenges. In particular, additional challenges may be introduced because the container contains a volume of gas. For example, if a very small leak is present in the container walls or one of the container welds, the container may bleed gas for a very long time. For example, when the container is placed in the vacuum chamber, gas may bleed from it for weeks or months. This may make it impossible for the vacuum chamber to reach a deep vacuum, namely a very low pressure. Such leaks may be very difficult to locate.

Furthermore, the gas trapped in the container may cause a deformation of the container. The deformation may vary with the pressure outside the container, namely the pressure within the vacuum chamber. This deformation can cause errors in the performance of components mounted within the container and/or other components within the vacuum chamber.

Furthermore, the gas trapped within the container results in stresses on the container and the welds when the pressure surrounding the container is reduced. This may result in a failure of the container. Alternatively or additionally, it is therefore desirable to provide a container with sufficiently thick walls to withstand such stress. This may increase the mass of the container, which may be undesirable. For example, this may in turn increase the mass of a sub-system of the lithographic apparatus that is moved. This in turn may require a more powerful actuator system for moving the sub-system, may result in an increase in the heat to be dissipated from such an actuator system and/or may reduce the accuracy and/or the rate of response of the actuator system.

It has previously been proposed to reduce the challenges discussed above by filling the container with a polymer, such as a low-viscosity epoxy. However, it has been found that this introduces additional challenges.

Therefore, in the present invention, it has been identified that a component for a lithographic apparatus may be housed within an internal space of a sealed container that is to be provided within the vacuum chamber. At least part of the internal space of the container may be filled with a packing material that comprises a plurality of gas cells.

The provision of an arrangement as described above may substantially reduce the final mass of the container compared with a container in which the internal space is filled with an epoxy, which may have a density of, for example, 95% to 200% the density of water.

FIG. 4 depicts a lithographic subsystem according to an embodiment of the invention. As shown, a container 40 is provided that may be installed within a vacuum chamber 35 of a lithographic apparatus. The container 40 may, for example, be formed from thin metal panels 41 that are secured to each other in a sealing manner, for example by welds 42. The panels may, for example, be formed from titanium, such as Ti grade 5, or stainless steel, such as AISI316L or AISI310S. The walls may have a thickness of between about 0.2 mm and about 1.5 mm. Thinner walls may be used, for example walls as thin as about 0.01 mm may be used.

One or more components 45 of the lithographic apparatus may be mounted within the internal space 43 of the container 40. For example, components of the lithographic apparatus that may be desirably housed in a container 40 rather than directly within a vacuum chamber 35 of the lithographic apparatus include sensors and coils and/or magnets that may form part of an actuator system.

As shown in FIG. 4, in an embodiment of the invention, sections 46 of a packing material comprising a plurality of gas cells are provided in order to at least partially fill the internal space 43 of the container 40. By providing such a packing material 46, free gas may be eliminated from the internal space 43 of the container, avoiding the challenge of a gas filled container discussed above. However, by use of a packing material having a plurality of gas cells, one may avoid challenges incurred by filling the container 40 with a polymer, such as an epoxy. For example, the density of a packing material comprising gas cells may be significantly lower than that of an epoxy. Therefore, the mass of the completed container may be significantly less than one filled with an epoxy.

Furthermore, the packing material may be a relatively poor thermal conductor. Therefore, the use of the packing material may reduce the transfer of heat that may be generated in the component to the walls of the container. This may reduce distortion of the container due to thermal expansion and/or reduce the further transfer of heat into the remainder of the lithographic apparatus.

The packing material may, for example, be formed from at least one of a polymethacrylimide rigid foam such as Rohacell produced by Evonick GmbH, an extruded polystyrene foam such as Styrofoam produced by the Dow Chemical Company, an expanded polystyrene foam, foam rubber such as neoprene produced by DuPont, balsa wood and other similar materials such as a solidified foam. The gas cells within the packing material may preferably be closed cells in order to prevent the packing material absorbing gasses or liquids during manufacture and/or leaking gasses or liquids during use.

The packing material may be selected such that it is less stiff than at least one of the container 40 and the component 45 housed within the container. Accordingly, if the one or more components 45 housed within the container 40 expand, for example as a result of a change in temperature, the packing material 46 may absorb the strain, namely may deform. This may prevent deformation of the one or more components 45 and/or the container 40.

Similarly, if the coefficient of thermal expansion of the packing material is different from that of the one or more components 45 and/or the container 40, the packing material 46 may deform if the temperature changes rather than the one or more components 45 and the container 40. This is in contrast to an arrangement in which the container is merely filled with a polymer, such as epoxy, as previously suggested. In such a container, the thermal expansion of the epoxy and/or the thermal expansion of the component housed within the container may result in deformation of the component or the container.

In order to form the container 40 of the embodiment depicted in FIG. 4, the following process may be used. Firstly, the container 40 may be partially formed and the component 45 of the lithographic apparatus may be located within it. Pre-formed sections 46 of packing material may also be located within the partially formed container 40. It will be appreciated that it may be necessary to provide at least one of the pre-formed sections 46 of packing material prior to the installation of the component 45. Alternatively, they may all be provided after the component 45. Once the pre-formed sections 46 of packing material are located within the container 40, the container may be completed, for example by the attachment, and sealing, of a final panel 41.

The pre-formed sections 46 of packing material may be formed such that, when the one or more sections are located within the container 40 with the component 45, the entirety of the internal space 43 of the container is filled. In one arrangement, the one or more sections 46 of the packing material may be designed to be slightly too large for the space to be filled such that the packing material must be slightly compressed to fit within the internal space 43 of the container 40. By means of such an arrangement, it may be ensured that no voids remain.

Alternatively or additionally, as depicted in FIG. 4, any voids remaining around the components 45 and the sections 46 of the packing material may be filled by a filler material, such as a polymer 48. For example, once the container 40 has been completed (with the sections of packing material inside), a polymer 48 may be injected into the internal space 43 of the container 40 in order to fill any voids remaining. Accordingly, for example, a port 49 may be provided within the container 40 through which the polymer 48 may be injected. In one arrangement, the container 40 may be evacuated prior to the injection of the polymer 48. Such an arrangement may reduce the likelihood of gas pockets remaining within the container 40 after the polymer 48 has been injected.

An arrangement such as discussed above, in which at least part of the internal space 43 of the container 40 around the component 45, and possibly most or all of the available internal space, is filled with a packing material, may have further advantages over a previously suggested container in which the internal space is filled with a polymer. For example, most polymers shrink significantly during curing, typically up to 3 or 4%. Therefore, if a container is primarily filled with polymer, the curing process may result in deformation of the container, resulting in the associated challenges discussed above. In an embodiment of the invention, some or all of the internal space of the container 40 around the component 45 may be filled with the packing material. Therefore, the challenges caused by the curing of a polymer may be reduced or eliminated.

It should be appreciated that in an embodiment of the present invention in which a polymer is injected to fill voids around the packing material and the component, the volume of polymer required may be sufficiently small that the shrinkage of that amount of polymer does not cause significant deformation of the container 40. Alternatively or additional, as discussed above, the shrinkage of the polymer may be accommodated by a deformation of the packing material rather than by a deformation of the container 40.

In methods such as those discussed above for forming a container 40 housing a component 45 of a lithographic apparatus, the polymer may be injected into the internal space 43 of the container 40 under a relatively high pressure in order to ensure that the polymer 48 fills all of the remaining voids. For example, the polymer 48 may be injected into the container 40 at a pressure of between about 1 bar and about 10 bars, for example about 3 bars, about 4 bars, or about 6 bars. Accordingly, the packing material may be selected to be sufficiently strong that it does not compress beyond a certain threshold when under the pressure used to inject the polymer 48. At the very least, it will be appreciated that the packing material may be selected such that it is not compressed to such an extent that the gas cells within the packing material burst under the pressure to be used.

Likewise, if the container 40 is to be evacuated prior to the injection of the polymer 48, the packing material may be selected such that it can withstand the evacuated conditions, namely such that when the pressure is reduced to the required level, the gas cells within the packing material do not burst. It will be appreciated that any pressure below atmospheric pressure may be used. In particular, the container 40 may be reduced to a pressure of between about 0.05 bar and about 0.1 bar. Therefore, the packing material may be selected to withstand evacuation to at least these pressures. The packing material may be selected such that it is significantly strong that it would withstand an absolute vacuum, namely the maximum stress that may be exerted by an under-pressure. It will be appreciated that such a pressure may not then actually be used in the process of forming the container.

As discussed above, it is desirable for the mass of the completed container 40 to be minimized. Accordingly, the packaging material may be selected to have as low a density as possible whilst providing the required mechanical properties. Preferably, the density of the packing material should be less than about 100 kg/m³. This may provide a significant weight saving in comparison to the previously suggested use of a low-viscosity epoxy, which may have a density of between about 900 kg/m³ and about 2000 kg/m³. For example, a polymethacrylimide foam may have a density of between about 30 kg/m³ and about 75 kg/m³, an extruded polystyrene foam may have a density of between about 30 kg/m³ and about 60 kg/m³ and an expanded polystyrene foam may have a density of between about 15 kg/m³ and about 50 kg/m³.

It will be appreciated that there may be tradeoff between the density of the packing material and the strength of the packing material. In particular, although the packing material may be selected such that it deforms rather than the component 45 or the container 40, it may be desirable for the packing material to provide some strength to the container 40. For example, the packing material may provide some strength and rigidity to the container 40 by supporting the panels 41. Accordingly, the use of a slightly stronger packaging material may enable the use of thinner panels 41 to form the container 40. The consequent reduction in the mass of the walls of the container may offset the increase in mass that may be necessary to provide the stronger packaging material, possibly resulting in a reduced mass of the completed container 40.

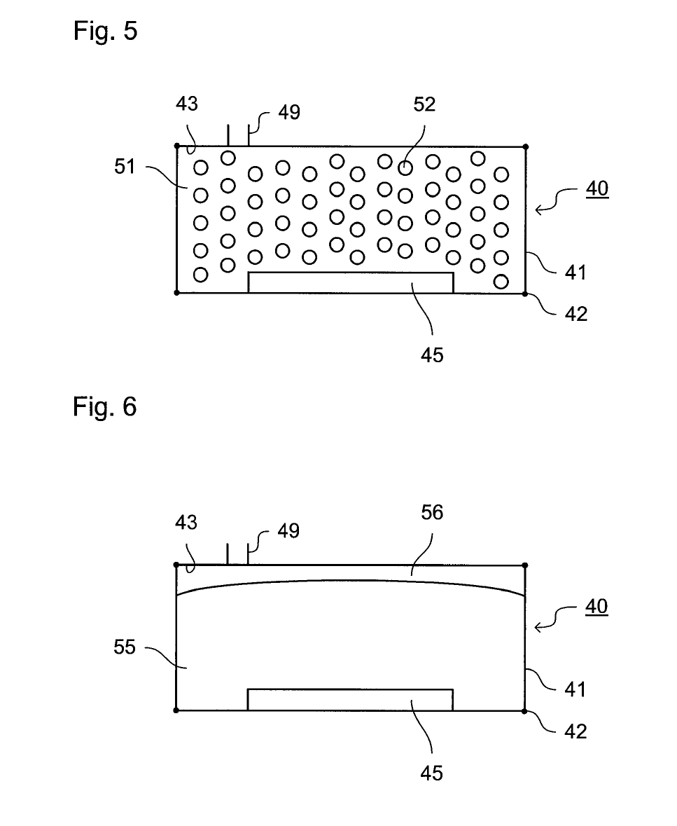

FIG. 5 depicts a lithographic apparatus subsystem according to an embodiment of the invention. This embodiment is similar to the embodiment depicted in FIG. 4 and, accordingly, only the differences will be discussed in detail. As shown, in this embodiment, the component 45 is housed within a container 40 and the remainder of the internal space 43 of the container 40 is filled by a packing material 51, 52. In particular, the packing material 51, 52 may comprise a polymer, such as an epoxy resin 51 in which a plurality of microballoons 52 are dispersed throughout the polymer 51. The microballoons 52 may, for example, be small hollow glass or phenolic material spheres. Such microballoons may have a density of about 120 kg/m³ to about 200 kg/m³.

In order to form the container of the embodiment depicted in FIG. 5, the component 45 of the lithographic apparatus may be located within the container 40 and the container completed as discussed above. Thereafter, the polymer 51 with the dispersion of microballoons 52 may be injected into the internal space 43 of the container 40 through the port 49. In a similar manner to that discussed above, in order to avoid the inclusion of gas pockets within the container 40, the internal space 43 may be evacuated prior to the injection of the polymer 51 and the microballoons 52.

In a variant of the embodiment depicted in FIG. 5, one may instead of injecting a polymer 51 with a dispersion of microballoons 52 into the container, inject a mixture of a polymer and a foaming agent. Accordingly, in such an arrangement, the packing material would consist of a polymer filled with gas bubbles.

FIG. 6 depicts a lithographic apparatus subsystem according to an embodiment of the invention. Again, only the features that differ from the above embodiments are discussed in detail. As shown, a component 45 is housed within a container 40. A packing material 55 is provided that fills most of the internal space 43 of the container around the component 45. In addition, a polymer 56 is provided in order to fill any remaining voids in the internal space 43 of the container 40.

In order to form the container of the embodiment depicted in FIG. 6, the packing material 55 may be injected through port 49 after the container 40 is sealed with the component 45 within it. In other words, in contrast to the embodiment depicted in FIG. 4, the packing material, including the gas cells, is formed within the internal space 43 of the container 40 rather than pre-formed and placed within the container 40.

However, as depicted in FIG. 6, a packing material formed in this way may not entirely fill the internal space 43 of the container 40. This may especially be the case because the packing material 55 may contract during curing, for example. Therefore, after the formation of the packing material 55, which fills the majority of the available space within the internal space 43 of the container 40, a polymer 56 may be injected through the port 49 in order to fill the remaining voids. As discussed above, the internal space 43 of the container 40 may be evacuated prior to the injection of the polymer 56.

Although the invention has been described above in the particular context of the preparation of a component sealed within a container to be placed within a vacuum chamber, it should be appreciated that the arrangement of the component within the sealed container may also be used in other contexts. For example it may be provided to a lithographic apparatus operating at atmospheric pressure. In this context, the invention may beneficially assist in preventing the transfer of contaminants between components located within and outside the container.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. The descriptions above are intended to be illustrative, not limiting. Thus it will be apparent to one skilled in the art that modifications may be made to the invention as described without departing from the scope of the claims set out below.

What is claimed is:

1. A lithographic apparatus subsystem, comprising:
a sealed container housing at least one component of the lithographic apparatus within an internal space of the sealed container, wherein at least part of the internal space of the container is filled with a packing material comprising a plurality of gas cells.

2. The lithographic apparatus subsystem according to claim 1, further comprising a vacuum chamber configured to be evacuated, wherein the sealed container is provided within the vacuum chamber.

3. The lithographic apparatus subsystem according to claim 1, further comprising a filler material, wherein the filler material is arranged to fill voids around the at least one component of the lithographic apparatus and the packing material such that the entirety of the internal space of the container is filled by said at least one component of the lithographic apparatus, the packing material, and the filler material.

4. The lithographic apparatus subsystem according to claim 1, wherein the gas cells within the packing material are closed cells.

5. The lithographic apparatus subsystem according to claim 1, wherein the sealed container and the at least one component of the lithographic apparatus are stiffer than the packing material.

6. The lithographic apparatus subsystem according to claim 1, wherein the packing material includes at least one material selected from the group consisting of a polymethacrylimide rigid foam, an extruded polystyrene foam, an expanded polystyrene foam, foam rubber, balsa wood, and microballoons.

7. The lithographic apparatus subsystem according to claim 1, wherein the density of the packing material is less than about 100 kg/m³.

8. The lithographic apparatus subsystem according to claim 1, wherein the sealed container is formed from metal panels.

9. The lithographic apparatus subsystem according to claim 1, wherein said at least one component of the lithographic apparatus comprises a sensor, a coil, or a magnet, or any combination thereof.

10. The lithographic apparatus subsystem according to claim 1, wherein the entirety of the internal space of the container is filled by said at least one component of the lithographic apparatus and the packing material, and wherein the packing material comprises a polymer mixed with a foaming agent.

11. A method of preparing a sealed container for use in a lithographic apparatus, comprising:
providing at least one component of the lithographic apparatus within an internal space of the container; and
providing a packing material to the internal space of the container, wherein the packing material comprises a plurality of gas cells.

12. The method of claim 11, further comprising installing the sealed container in a vacuum chamber for use in the lithographic apparatus.

13. The method of claim 11, further comprising providing a filler material to the internal space of the container so as to fill voids around the at least one component of the lithographic apparatus and the packing material such that the entirety of the internal space of the container is filled by said at least one component of the lithographic apparatus, the packing material, and the filler material.

14. The method of claim 13, wherein the pressure in the internal space of the container is reduced to pressure of between about 0.05 bar and about 0.1 bar prior to the filler material being provided to the internal space of the container.

15. The method of claim 11, wherein the packing material is formed in a desired shape before being placed in the internal space of the container.

16. The method of claim 15, wherein the container is sealed after the packing material is placed in the internal space of the container.

17. The method of claim 11, wherein the packing material is formed in a desired shape within the internal space of the container.

18. The method of claim 11, wherein said providing the packing material to the container comprises injecting a mixture of a polymer and at least one of microballoons and a foaming agent into the sealed container.

19. A container for use within a lithographic apparatus, the container housing at least one component of the lithographic apparatus within an internal space which is at least partially filled with a packing material comprising a plurality of gas cells.

20. A lithographic apparatus comprising:
a support configured to support a patterning device, the patterning device being configured to pattern a beam of radiation to form a patterned beam of radiation;
a projection system configured to project the patterned beam of radiation onto a substrate; and
a lithographic apparatus subsystem, comprising
a sealed container housing at least one component of the lithographic apparatus within an internal space of the sealed container, wherein at least part of the internal space of the container is filled with a packing material comprising a plurality of gas cells.
